(19) United States
(12) Patent Application Publication
(10) Pub. No.: US 2014/0310237 A1
(43) Pub. Date: Oct. 16, 2014

(54) BUILDING A DIGITAL MEDIA LIBRARY FROM TWO OR MORE SEPARATE DIGITAL MEDIA SOURCES

(71) Applicant: Crestron Electronics, Inc., Rockleigh, NJ (US)

(72) Inventors: Korhan M Baydurcan, Wayne, NJ (US); Robert A Lopresti, Garnerville, NY (US)

(73) Assignee: Crestron Electronics, Inc., Rockleigh, NJ (US)

(21) Appl. No.: 14/253,115

(22) Filed: Apr. 15, 2014

Related U.S. Application Data
(60) Provisional application No. 61/812,026, filed on Apr. 15, 2013.

(51) Int. Cl. G06F 17/30

(52) U.S. Cl. CPC G06F 17/30289
USPC 707/609; 707/802; 707/737

(57) ABSTRACT

Presented is a method of building a digital media library from separate digital media sources. The method includes providing a location of each of the separate media sources, where each of the media sources stores at least one digital media item, and the media item is either owned, rented, or saved by a user. The method further includes accessing the location of each of the separate media sources and collecting reference location information and metadata associated with the media item stored at each of the media sources. The method further includes consolidating and storing the reference location information and the metadata associated with the media item from each of the media sources into a database, presenting the information stored in the database in readable form, and providing a message indicating the availability of, the expiration of, or the time left before expiration of at least one of the media items.

### BACKGROUND OF THE INVENTION

1. Technical Field

The present invention relates generally to digital media libraries, and more particularly a system and method for creating a master digital media library from separate digital media sources.

2. Background

Typically, when a user wants to browse the digital media (e.g., digital audio, digital video, digital images) he/she currently has available for viewing, the user must browse more than one library. For example, a user may first browse digital media stored on a local storage drive, and then a network storage drive to see what is available. Failing to find anything desirable, the user may next login to a first content provider (e.g., Netflix®) to view his/her movie queue to find desired content. If the user still fails to find anything desirable, the user may then login to another content provider (e.g., Hulu®) to browse his/her favorites. The user may repeat this library browsing process for each of the content providers with which the user has free access, a subscription membership, or a pay per view membership. Further, when browsing different digital media libraries, a user must use the graphical user interface associated with the particular digital media library being browsed. Each such graphical user interface has its own controls, menus, and presentation of available digital media, and thus requires the user to adapt to each different library browsing process. Consequently, there exists a need for a system and method for collecting all of a user's available digital media content into a single digital media library, regardless of the sources of such digital media content, and presenting the user's available digital media content to the user using one graphical user interface.

### SUMMARY OF THE INVENTION

It is to be understood that both the general and detailed descriptions that follow are exemplary and explanatory only and are not restrictive of the invention.

### DISCLOSURE OF THE INVENTION

In one aspect, the invention involves a method of building a master digital media library from a plurality of separate digital media sources. The method includes the steps of providing a location of each of the plurality of separate digital media sources, where each of the plurality of separate digital media sources stores at least one digital media item, and the at least one digital media item is either owned by a user, rented by the user, saved to a queue by the user, or bookmarked by the user. The method further includes accessing the location of each of the plurality of separate media sources and collecting from each of the plurality of separate media sources reference location information and metadata associated with the at least one digital media item stored at each of the plurality of separate digital media sources. The method further includes consolidating and storing the reference location information and the metadata associated with the at least one digital media item from each of the plurality of separate media sources into a database, and presenting to the user the information stored in the database in readable and searchable form.

In another aspect, the invention involves a method of building a master digital media library from a plurality of separate digital media sources. The method includes the steps of providing a location of each of the plurality of separate digital media sources, where each of the plurality of separate digital media sources stores at least one digital media item, and the at least one digital media item is either owned by a user, rented by the user, saved to a queue by the user, or bookmarked by the user. The method further includes accessing the location of each of the plurality of separate media sources and collecting from each of the plurality of separate media sources reference location information and metadata associated with the at least one digital media item stored at each of the plurality of separate digital media sources. The method further includes consolidating and storing the reference location information and the metadata associated with the at least one digital media item from each of the plurality of separate media sources into a database, presenting to the user the information stored in the database in readable and searchable form, and providing to the user a message indicating one of the availability of, the expiration of, the time left before the end of a blackout period of, or the time left before expiration of at least one of the at least one digital media item from each of the plurality of separate media sources.

In yet another aspect, the invention involves a system for building a master digital media library from a plurality of separate digital media sources. The system includes an input module configured for receiving and storing a location of each of the plurality of separate digital media sources, where each of the plurality of separate digital media sources stores at least one digital media item, and the at least one digital media item is either owned by a user, rented by the user, saved to a queue by the user, or bookmarked by the user. The system further includes a collecting module configured for accessing the location of each of the plurality of separate media sources and collecting from each of the plurality of separate media sources reference location information and metadata associated with the at least one digital media item stored at each of the plurality of separate digital media sources. The system further includes a consolidating module configured for consolidating and storing the reference location information and the metadata associated with the at least one digital media item from each of the plurality of separate media sources into a database. The system further includes a presenting module configured for presenting to the user the information stored in the database in readable and searchable form, and for providing to the user a message indicating one of the availability of, the expiration of, the time left before the end of a blackout period of, or the time left before expiration of at least one of the at least one digital media item from each of the plurality of separate media sources.

In still another aspect, the invention involves a method of building a master digital media library from at least one digital media source. The method includes providing a location of the at least one digital media source, where the at least one digital media source stores at least one digital media item, and the at least one digital media item is either owned by a user, rented by the user, saved to a queue by the user, or bookmarked by the user. The method further includes accessing the location of the at least one digital media source, and collecting from the at least one digital media source reference location information and metadata associated with the at least one digital media item. The method further includes consolidating and storing the reference location information and the metadata associated with the at least one digital media item from the at least one digital media source into a database, and presenting to the user the information stored in the database in readable and searchable form. The method further includes providing to the user a message indicating either the availability of, the expiration of, the time left before the end of a blackout period of, or the time left before expiration of the at least one digital media item from the at least one digital media source.

### BRIEF DESCRIPTION OF DRAWINGS

The accompanying figures further illustrate the present invention. Exemplary embodiments are illustrated in reference figures of the drawings. It is intended that the embodiments and figures disclosed herein are to be considered illustrative rather than limiting.

The components in the drawings are not necessarily drawn to scale, emphasis instead being placed upon clearly illustrating the principles of the present invention. In the drawings, like reference numerals designate corresponding parts throughout the several views.

FIG. 1 shows an illustrative block diagram of a digital media library system in communication with a plurality of devices, according to one embodiment of the invention.

FIG. 2 shows an illustrative block diagram of the digital media library system of FIG. 1.

FIG. 3 is an illustrative schematic diagram of the digital media delivery device of FIG. 2.

FIG. 4 is an illustrative block diagram of the search mechanism of the media delivery device of FIG. 3.

FIG. 5 is an illustrative flow diagram of a collect, group, filter, sort, and display process using a digital media delivery device, according to one embodiment of the invention.

FIG. 6 is an illustrative flow diagram of a digital media availability notification process, according to one embodiment of the invention.

FIG. 7 is an illustrative diagram of master media library presentation screen, according to one embodiment of the invention.

### LIST OF REFERENCE NUMBERS FOR THE ELEMENTS IN THE DRAWINGS

The following is a list of the major elements in the drawings in numerical order.
100 digital media system
101 digital media delivery device
102 keyboard
104 display
106 touch panel
108 digital video recorder (DVR)
110 mobile phone
112 home theater personal computer
114 digital camera
115 video camera
120 personal computer
126 laptop/notebook computer
128 network attached storage
130 router
136 network
138a remote server
138b remote server
138c remote server
140a remote media storage
140b remote media storage
140c remote media storage
142 DVD or Blu-Ray disc changer
144 local external hard drive
148 remote control device
150 pointing device
301 chassis
302 main processor board
304 volatile random access memory
308 processor
309 video processor
310 mass storage device
312 power supply
314 CD/DVD drive
316 video card
318 sound card
320 LAN card
322 touch panel card
324 monitor connector
326 audio connector
328 LAN connector
330 touch panel connector
332 keyboard connector
334 pointing device connector
336 power supply connector
338 mass storage device connector
340 control dial
342 LCD panel
344 control buttons
346 control panel
348 control panel connector
350 A/C connector
400 search mechanism
402 input control module
406 display control module
408 playback module
410 presenting module
412 consolidating module (aggregator)
414 searching module (indexer)
418 sorter module
420 filter module
422 grouping module
502 Execute a build library command
504 Access each of a plurality of digital media sources for digital media items
506 Collect reference location and metadata for each of the digital media items from each of the plurality of digital media sources
508 Consolidate and store the reference location and metadata collected from each of the plurality of media sources into a database
510 Present/Display media items to the user
602 Access each of a plurality of media sources for new media items and updated information for existing media items
604 Collect reference location and metadata for each of the new media items and collect updated information for existing media items
606 Consolidate and store the reference location and metadata collected from each of the plurality of media sources into a database/update existing media item information
608 Present/Display media items to the user
610 Display availability/expiration information for each of the media items
700 Master media library presentation screen
702 Search button
704 Sort button
706 Group button
708 Filter button
710 Media item display area
712a-j Picture representing content
714a-j Media title
716 Expires in 2 days notification message
718 Expires in 14 days notification message
720 Not available notification message
722 Available in 3 days notification message
724 Footer area
726 Expired

### DETAILED DESCRIPTION OF THE INVENTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”.

### MODE(S) FOR CARRYING OUT THE INVENTION

The present disclosure involves a system and method for creating a single master digital media library (“master library”) from separate digital media sources (“media sources”). More specifically, the disclosed system and method allows a user to create a single master digital media library by combining separate and disconnected digital media sources, such as a local digital media library (on a local storage drive), a network digital media library (on a local area network storage drive), bookmarked favorites (i.e., movie or music queue) from one or more content providers (e.g., Netflix®, Hulu®, Amazon®, YouTube®, etc.), a library of purchased or rented media (e.g., Vudu®) and digital media stored on CD, DVD, or Blu-Ray™ changers.

Digital media (“media”) includes, but is not limited to, movies, TV shows, videos, still pictures, audio (e.g., music, books on disk, recorded lectures), and text documents (including text only and text with graphics), and combinations thereof. The various digital media can be in any format known to those skilled in the art.

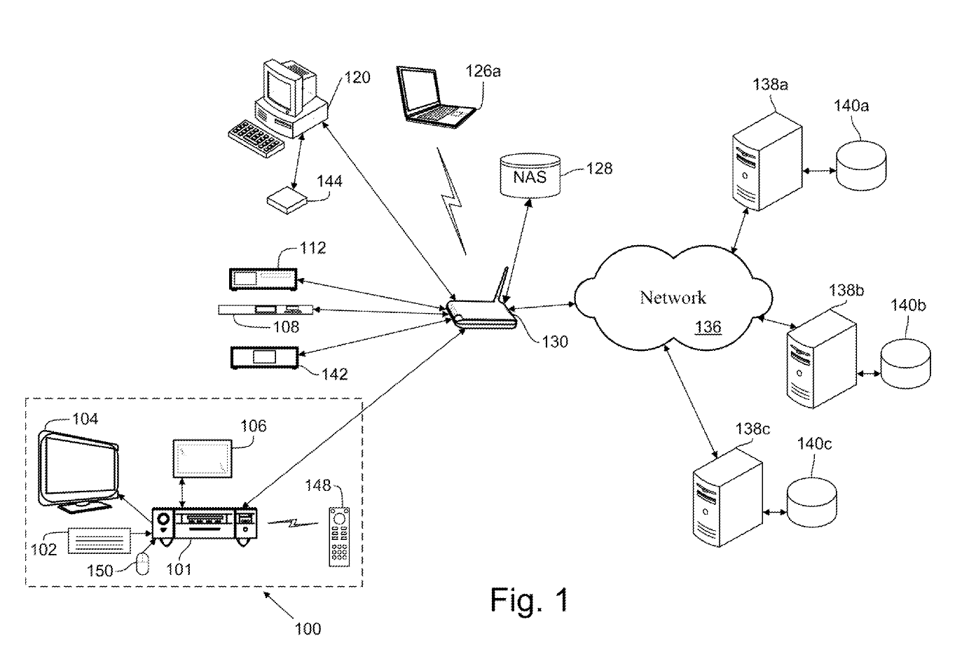

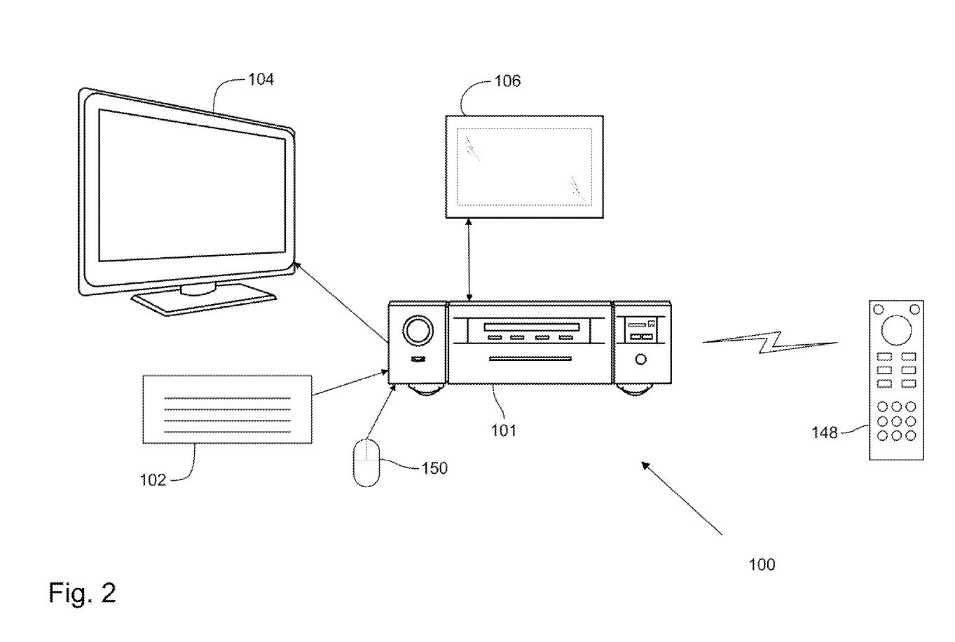

Referring to FIG. 1, in one embodiment, a block diagram of a digital media library system 100 in communication with a variety of devices capable of storing digital media is shown. The library system 100 includes a digital media delivery device 101, a wired or wireless keyboard 102 and a wired or wireless pointing device (e.g., mouse 150) for data entry and selection, and a display 104 (e.g., an LCD monitor or television) for viewing library entries and viewing selected digital media (see also FIG. 2).

In another embodiment, the library system 100 includes the digital media delivery device 101, the monitor 104 for viewing media, and a touch panel 106 (also shown in FIG. 2), which is used for data and query entries, and viewing search results. The touch panel 106 includes various touch controls and a virtual keyboard for alphanumeric data entry, as is known to those skilled in the art. In still another embodiment, the touch panel 106 is also used for viewing digital media playback.

In still another embodiment, the library system 100 includes a remote control device 148, which is used to configure and control the media delivery device 101 by methods known to those skilled in the art.

Referring again to FIG. 1, the media delivery device 101 is in communication with a plurality of digital media sources. Generally, a “digital media source” is any electronic device that stores or provides digital audio, video, still images, and/or digital documents. Such electronic devices include, but are not limited to, a home theater personal computer (HTPC) 112, a DVR 108, a DVD and/or Blu-Ray Disc® changer 142, a mobile phone 110, a digital camera 114 (still image), a digital video camera 115, a personal computer (PC) 120, laptop/notebook computer 126a, a network attached storage (NAS) 128, a local external hard drive 144, a tablet computer, or an MP3 player.

In one embodiment, the digital media sources local to the media delivery device 101 are in communication with the media search device 101 via wired or wireless connections through a router 130 in a home or local area network (LAN).

A “digital media source” also includes any remote digital media provider, such as YouTube®, iTunes®, Hulu®, Vudu®, Amazon Video on Demand®, or Netflix®, that provides digital media (“media”) over a network (e.g., the internet). The digital media can be downloadable or streaming, and can be free, rented, subscription based, or purchased.

Referring still to FIG. 1, media providers that provide digital media over a network are represented by remote server 138a and remote media storage 140a, remote server 138b and remote media storage 140b, and remote server 138c and remote media storage 140c. In other embodiments, the media delivery device 101 can be in communication with more or less media sources. The remote server 138a, remote media storage 140a, remote server 138b, and remote media storage 140b are in communication with the media delivery device 101 via the network 136 and router 130.

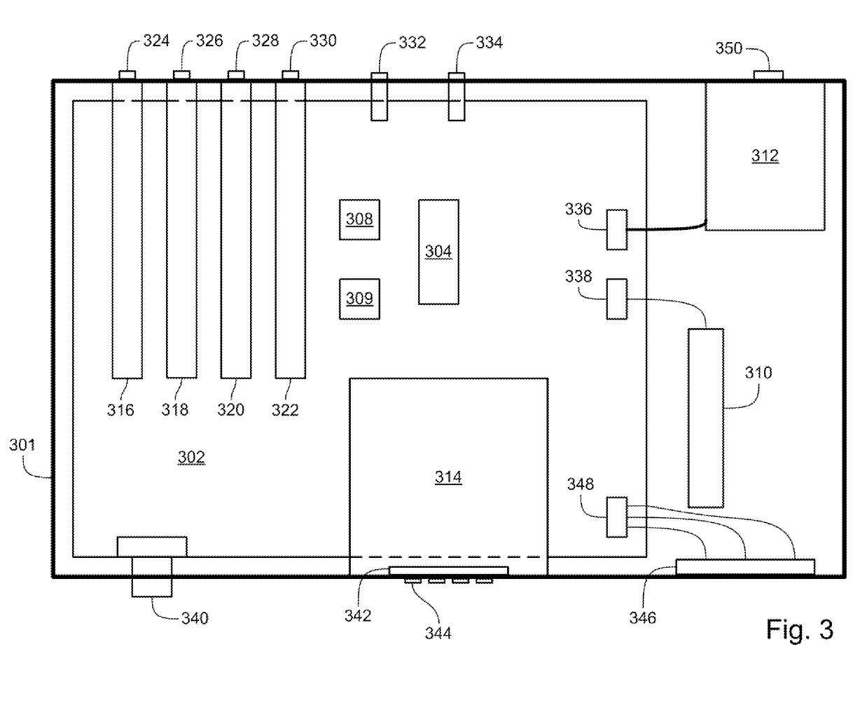

Referring to FIG. 3, in one embodiment, a schematic diagram of the media delivery device 101 is shown. The media delivery device 101 includes a main processor board 302 (e.g., an Intel motherboard), which includes volatile random access memory (VRAM) 304, a main processor 308, a keyboard connector 332, a pointing device connector 334, a power supply 312 with an A/C connector 350, a mass storage device (e.g., a Seagate hard disk or solid state drive) 310, and CD/DVD drive 314. The main processor 308 is configured to execute all of the media delivery functions, which are described in detail below. The mass storage device 310 is configured to store the master digital media library.

The power supply 312 is connected to the main processor board 302 via connector 336 and the hard disk 310 is connected to the main processor board 302 via connector 338.

The media delivery device 101 further includes at least one of a video card 316 (e.g., an ATI video card) with a video connector 324 and/or a dedicated video processor 309 disposed on the main processor board 302. The media delivery device 101 further includes a sound card 318 with an audio connector 326, a LAN card 320 with a LAN connector 328, and a touch panel interface card 322 with a touch panel connector 330. The various cards are seated in card slots (not shown) disposed on and connected to the main processor board 302.

The media delivery device 101 still further includes a control knob 340, an LCD screen 342, control buttons 344, and a control panel 346 each connected to the main processor board 302. The control panel 346 is connected to the main processor board 302 via connector 348. In other embodiments, more or less controls are included.

The above-described components are all disposed in, or on, a chassis 301.

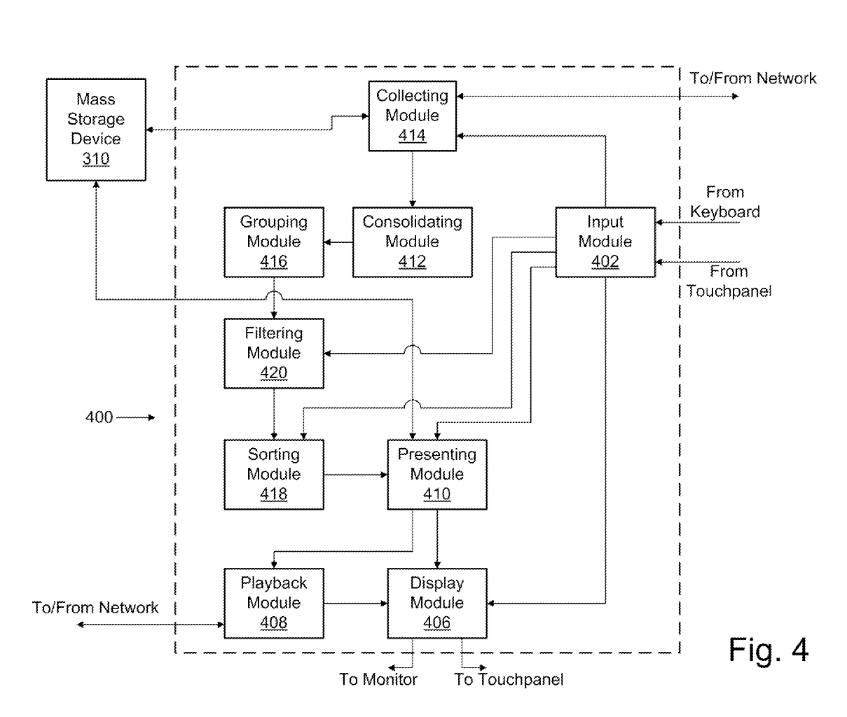

Referring to FIG. 4, in one embodiment, a block diagram of the media delivery mechanism 400 of the media delivery device 101 is shown. The media delivery mechanism 400 includes an input control module 402, display module 406, a playback module 408 (playback engine), a presenting module 410, a consolidating module 412, and collecting module 414, a grouping module 416, a sorting module 418, and a filter module 420. Each of the modules 402, 406, 408, 410, 412, 414, 416, 418, 420 is discussed in detail below.

The input control module 402 (which includes a graphical user interface) receives user input from the keyboard 102 and mouse 150, or remote 148, or touch panel 106 and enables a user to browse the master media library for digital media items, update the master media library (e.g., add or delete digital media items), input a digital media search term, select filtering and sorting options, select a particular digital media item for viewing, and select the particular display device on which the selected digital media item is to be viewed. The method of selecting the particular display device on which the digital media is to be viewed is beyond the scope of this disclosure.

The input control module 402 also allows the user to configure where the collecting module 414 (discussed below) searches for a user's favorite digital media items. More specifically, the user, via the input control module 402, edits a configuration file of the collecting module 414 to include the locations of the user's favorite digital media items. For example, the user can edit the configuration file to include any hard drive or local area network locations (e.g., C:\My Documents\My Videos) where favorite digital media items are stored. Further, the user can edit the configuration file to include logins, passwords, and links for all of the user's free and paid (subscription and purchase/rent) digital media providers (e.g., Netflix, Amazon, Vudu, etc.). The user can also edit the configuration file to include any network attached devices that store digital media such as a DVD/CD jukebox or a DVR, for example.

In various embodiments, the input control module 402 enables the user to directly access free, subscription, or purchase/rent digital media providers, such as YouTube®, Hulu®, Vudu®, Amazon Video on Demand®, or Netflix®, for example, so that the user can purchase or rent new media or add new media to watchlists or queues, which are then automatically added to the users master media library, and is discussed in further detail hereinbelow.

The collecting module 414 is in communication with the router 130 and is configured to access locations of a user's favorite, free, rented, and paid for digital media items. The collecting module 414 is also configured to collect information associated with each of the user's favorite, free, rented, and paid for digital media items. Specifically, the collecting module 414 accesses/searches each of the digital media locations listed/stored in the collecting module 414 configuration file and collects/retrieves the reference locations (i.e., disk paths, digital file folder locations, drive locations, memory locations, uniform resource locators (URLs), etc.) and associated metadata for each of the user's favorite/bookmarked, free, purchased, and rented digital media items.

The metadata that is associated with a particular digital media item includes data that comprises information that describes the contents or attributes of that particular media item. Examples of metadata include, but are not limited to, title, subject, artist, creator, director, cast, composer, description, genre, type, filename, source, publisher, format, date of production, running time, media display image, language, media cost, and media availability. Media availability refers to any time limit for viewing the media (e.g., two day rental), media blackout dates (e.g., time period media is unavailable), media return dates (e.g., date when media is again available after a blackout period).

Sources of metadata include web page content, uniform resource locators (URLs), headers, and/or trailers of media files, and transport streams used to transmit media files. Web page content includes HTML, XML, JSON, metatags, and any other text on the web page. The collecting module 414 then passes the reference locations and metadata to the consolidating module 412.

In another embodiment, the collecting module 414 is configured to automatically download media items that are downloadable (i.e., offered for download rather than streaming) and have been paid for.

The consolidating module 412 consolidates the collected reference locations and metadata for each of the user's digital media items and persists the reference locations and the metadata to storage using methods known to those skilled in the art. For example, in various embodiments, the consolidating module 412 stores the reference locations and metadata for each of the user's digital media items in a single data file or database on the mass storage device 310. The user now has a master digital media library, which can be browsed, searched, sorted, filtered, and/or grouped according the user's preferences, and which allows a user to access and view any of his/her digital media from one location using one user interface regardless of the actual location of the particular digital media.

As an example, assume a user has five videos stored on his local hard drive, five purchased/rented videos stored at “Your Video Library” at Amazon.com, five movies listed on “Your Watchlist” at Amazon.com, five videos listed on his YouTube playlist, five movies listed on his Netflix movie queue, and five DVDs in his DVD jukebox. Next assume that the user has added each of the above locations, including any necessary login and password information to the collecting module 414 configuration file.

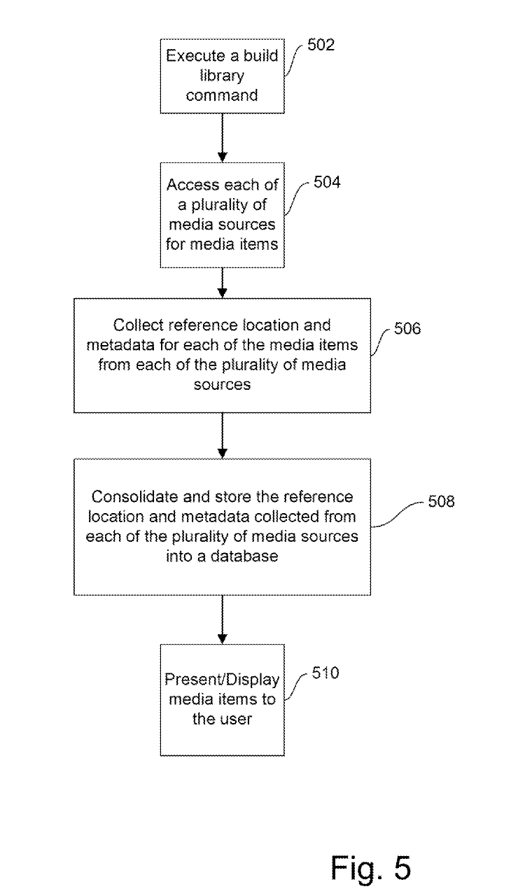

Referring to FIG. 5, and continuing with the above example, in one embodiment, a user initiates compiling/building a master media library by accessing the user's master video library via the input module 402 (Step 502). In other embodiments, the master media library is compiled automatically and periodically updated without any user interaction as long as the media delivery device 101 is powered on. The collecting module 414 accesses each of the locations listed in the configuration file (Step 504) and collects the reference location information and metadata for each of the separate digital media items from each of the user's separate libraries (e.g., local hard drive, Amazon Video Library, Amazon Watchlist, YouTube favorites, Netflix queue, and DVD jukebox) (Step 506).

In the above example, the collecting module 414 would collect reference location information and metadata for each of five media items at each of six locations (i.e., digital media sources). In other words, the collecting module 414 collects six sets of digital media item information/data, where each set of information/data includes reference location information and metadata for each of five digital media items. In another embodiment, the collection module also automatically downloads any paid-for downloadable media. The collecting module 414 then passes the collected reference location information and metadata to the consolidating module 412. The consolidating module 412 consolidates and stores the collected reference location information and metadata into a database (i.e., master digital media library) (Step 508).

Next, the presenting module 410 organizes the reference location information and the metadata for each of the digital media items in a presentable (i.e., user-readable) form and passes this information to the display module 406, which displays the information as a single/master digital media library on a display (e.g., monitor 104) for the user to view (Step 510). For example, in one embodiment, the presenting module 410 passes digital media display images along with associated digital media text descriptions to the display module 406 for display on the monitor 104. The user can now browse, search, sort, group, and/or filter the master digital media library using to the input module 402, as described below.

In one embodiment, the input module 402 allows a user to access various browsing, searching, sorting, grouping, and filtering features. The grouping module 416 is user configurable and analyzes the collected metadata associated with each of the digital media items and groups the digital media items according to user presets (e.g., by genre, year, media type, rating, etc). When analyzing/examining the metadata associated with a particular media item to determine if the particular media item belongs to a particular group, the grouping module 416 uses heuristic analysis and preset metadata matching criteria. In other words, the grouping module 416 determines if the media item's associated metadata reaches a predetermined metadata matching threshold.

The filtering module 420 is user configurable and filters (i.e., determines what is presented in/eliminated from) the listed/displayed digital media items according the user's preferences. For example, the digital media items listed/displayed may be filtered by: media type (e.g., all types, only video, only audio, or only images); the level of matching of input search term(s) (e.g., search for keyword(s), exact phrase, Boolean search, etc.); and run time of the media (e.g., any run time, only short videos, only full episodes, or only full length movies, etc). In other embodiments, in addition to, or instead of the above filters, the media items can be filtered according to other criteria, such as date, for example, or according on any other available metadata.

The sorting module 418 is user configurable and sorts the groups of media items with respect to each other and also sorts the media items within each of the groups according to the user's preferences. For example, groups of media items, or media items within groups can be sorted by resolution; Quality of Service (i.e., the bandwidth at which the file can be download or streamed); or purchase options (e.g., free, rental, purchase). In other embodiments, in addition to, or instead of the above sorting options, the digital media items can be sorted according to other criteria, such as date, for example, or according to any other available metadata.

In various embodiments, the user has the option of searching/browsing the media items, re-grouping the media items, re-sorting the media items, re-filtering the media items, adding or removing filtering criteria, and adding or deleting media items from the master media library, at any time and in any order.

The user may also at any time add additional libraries to combine with the user's existing master media library. For example, after the user's master library has been created, the user may subscribe to another media provider (e.g., Vudu), create a Vudu purchased/rented list, and thereafter have the collecting module 414 retrieve the Vudu purchased/rented list and add it to the user master library. If a user subsequently cancels his membership to a particular media provider, the media items retrieved from that media provider are automatically removed from the user's master library.

If the user chooses to select a particular media (e.g., video) for viewing, the user simply selects the media item by clicking on the associated link with the pointing device 150, via the touch panel 106, or using the remote control 148. In some embodiments, the associated link is embedded in the particular digital media display image or is a hypertext disposed proximate to the digital media display image.

After the particular digital media item is selected, the presenting module 410 instructs the playback module 408, which is communication with the router 130, to retrieve and playback the selected media. As mentioned above, prior to actually viewing the media, the user has the option of selecting on which display device the media is to be viewed.

In one embodiment, if the user wants to search for new media (i.e., media not in his/her master media library), the user can navigate out of the master media library to search for new media to be added to his/her master media library. The user can search for new media at any of the content providers with which the user has free access, a subscription membership, a pay per view membership (i.e., rental), or a library of paid for media. If the user finds new media, the user can add that new media to his/her master media library.

If the selected media is to be purchased or rented, the input module 402 interacts with a web/internet interface and the user is connected to the particular media provider's website for payment and download or streaming of the media. In another embodiment, payment is made automatically without user interaction. Once the media has been purchased/rented (i.e., selected, paid for, downloaded, etc.), the media is automatically added to the user's master media library and made available for viewing. If the selected media is free (e.g., available for free streaming or download from a media provider), the media is automatically added to the user's master media library and made available for viewing.

In other embodiments, if a user, through a content provider's website, adds new media items to a media queue of subscription service, or a library of purchased/rented media of a buy/rental service, or a favorites list of a free service, the new media items are added to the user's master media library when the master media library is updated.

In one embodiment, the media delivery device 101 automatically updates the master digital media library at a user configurable time and frequency (e.g., every night at 2 A.M.). In other embodiments, the user can manually instruct the media delivery device 101 to update the master digital media library.

In various embodiments, the modules 402, 406, 408, 410, 412, 414, 416, 418, 420 are implemented using C#, C, and C++ and executed on the main processor 308 (FIG. 3). In another embodiment, the modules 402, 406, 408, 410, 412, 414, 416, 418, 420 are executed on separate processors.

Although it has been disclosed that the media delivery device 101 is configured to build a master digital media library from two or more digital media sources, it should be noted, and one skilled in the art would understand, that the media delivery device 101 is in no way prevented from building a master digital media library from a single digital media source. For example, a user may have a membership to a single digital media provider and wish to build a master digital media library from that single source. The user would accomplish this using the functions/features described in detail above. The resulting master digital media library would have all the functionality and features described herein, including the messaging features described below, regardless of the fact that it was built from a single digital media source. If the user later decides to add new media sources, such as a DVD jukebox or through membership to additional media providers, these additional media sources can be easily added to the existing master digital media library, as described above.

In other embodiments, the master media library provides notifications to the user regarding availability of each media item (media availability). As described above, media availability refers to any time limit (i.e., expiration date) for viewing the media (e.g., two days to view rented media), media blackout dates (e.g., a period of time that media is unavailable), and media return dates (e.g., date when media is again available after a blackout period). Media availability information for each digital media item is obtained from the digital media item's metadata that is collected during the initial build of the master media library, as described above, and each time the master media library is updated, as described below.

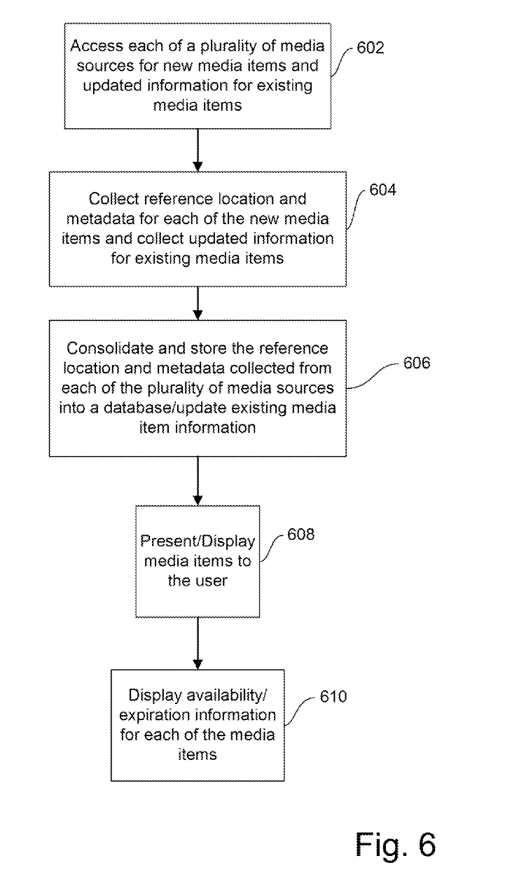

Referring to FIG. 6, in one embodiment, updating the master media library involves the collecting module 414 periodically and automatically accessing each of the plurality of media sources listed in the configuration file to look for new media items (added by the user) and updated information associated with media items previously stored in the database (Step 602). The collecting module collects the reference location information and metadata for newly added digital media items from each of the user's separate libraries (as described above) and collects updated reference location information and metadata for digital media items previously stored in the database (Step 604). The consolidating module 412 then consolidates and stores the collected new and updated reference location information and metadata into the database (i.e., master digital media library) (Step 606).

Thereafter, the presenting module 410 organizes the new and updated reference location information and metadata for each of the digital media items in a presentable (i.e., user-readable) form and passes this information to the display module 406, which displays the information as a single/master digital media library on a display (e.g., monitor 104) for the user to view (Step 608). Additionally, the display module 406 also displays availability/expiration information (received from the presenting module 410) for each of the media items that have particular availability/expiration dates or that have expired or become unavailable for viewing (Step 610).

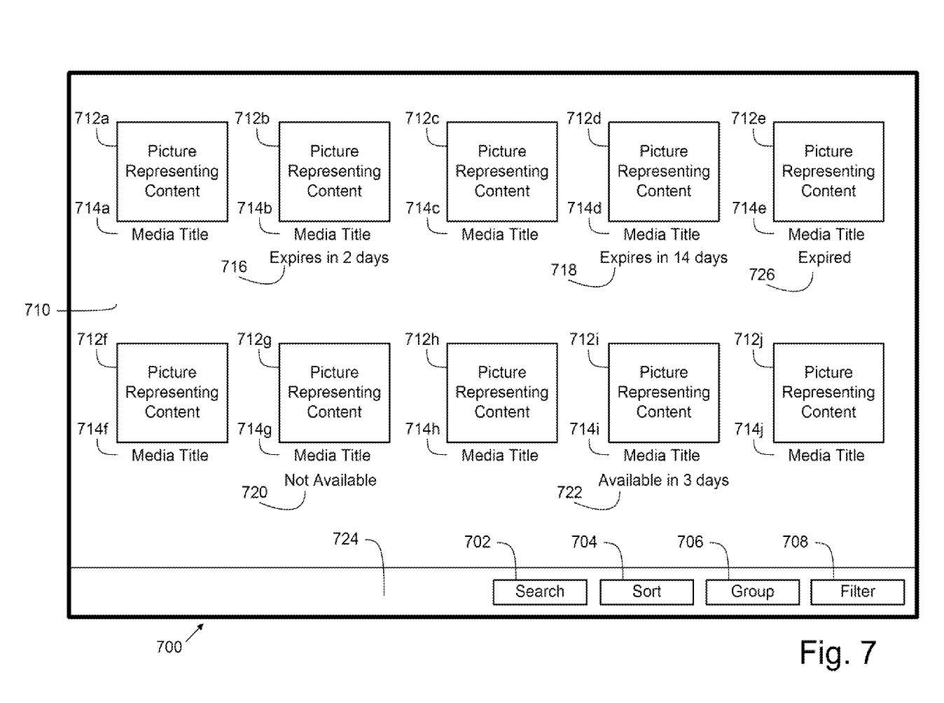

Referring to FIG. 7, in one embodiment, an illustrative diagram of master media library presentation screen 700. The master media library presentation screen 700 includes a media item display area 710 and a footer area 724 that includes a search button 702, a sort button 704, a group button 706, and a filter button 708. These buttons, when clicked/actuated via a mouse, remote, or keyboard, enable a user to execute the respective function as described hereinabove.

The display area 710 includes a plurality of pictures 712a-j and respective media titles 714a-j that represent the digital media items in the user's master digital media library. The number of media items displayed in the display area 710 depends on the number of media items in the user's library, the search terms used, and the filters used to limit the search. If all the media items returned in a particular search cannot fit in the display area 710, the user can scroll left or right, or up or down, to view the additional media items. In other embodiments, the media items can be shown in the display area 710 in a text only format.

Still referring to FIG. 7, five availability/expiration messages are shown. Specifically, the media item represented by picture 712b and title 714b has an associated message 716 indicating that it will expire in two days. Similarly, the media item represented by picture 712d and title 714d has an associated message 718 indicating that it will expire in fourteen days. An internal clock/calendar (part of the media delivery device 101 hardware and software) keeps track of the various media expiration dates and updates the various expiration messages accordingly as the respective expiration dates approach. In one embodiment, on the day a particular media item is to expire, the user will be presented with an expiration countdown clock that will count down to the expiration time. The frequency of notification is user configurable.

Still referring to FIG. 7, the media item represented by picture 712e and title 714e has an associated message 726 indicating that it has expired. The “expired” message applies to rental media and indicates that the rental period has expired. In some embodiments, the “expired” message along with the image of the media item will remain in the user's library until the user deletes it. In other embodiments the “expired” message and image of the media item will remain in the user's library for a predetermined amount of time.

The media item represented by picture 712g and title 714g has an associated message 720 indicating that it is not available. The “not available” message applies to media that is from a subscription service and the particular media is in a blackout period. The “not available” message will remain until the blackout period is over. In some embodiments, if a particular media item is in a blackout period, it will be automatically removed from the user's library, and then returned to the user's library when the blackout period is over.

In another embodiment, the “not available” message also applies to media that is not available because the electronic device storing the actual digital media has been disconnected from the user's network, or is inoperable. For example, a digital media item that is listed in the user's master digital media library and stored in a DVD jukebox would be listed as “not available” if the DVD jukebox was disconnected from the user's network, or if the DVD jukebox was not working. The “not available” message would remain until the DVD jukebox was reconnected to the user's network. Alternatively, a “device missing” message is used to indicate that the electronic device storing the actual digital media has been disconnected from the user's network, or is inoperable

In various embodiments, it is envisioned that if a particular digital media item is available for viewing and has no expiration date, no notification would need to be provided to explicitly indicate that the particular digital media item is available. In other words, there does not need to be an “available” message for a particular digital media item to indicate that the particular digital media item is in fact available. However, in some embodiments, such a message is provided.

The media item represented by picture 712i and title 714i has an associated message 722 indicating that it will be available in 3 days. A message of future availability applies to media that has been blacked out and the blackout period is known.

In another embodiment, expiration messages for all digital media with upcoming expiration dates are automatically displayed on the user's screen/monitor when the master digital media library is accessed. In yet another embodiment, availability/expiration messages are displayed in a header above the media display area. In still another embodiment, the user receives an email alert detailing the media items with time limits and the times left for viewing such media items.

In another embodiment, for each or some of the media items from a remote service provider that are listed in the user's master library, an encrypted file including a few minutes of content of that media is downloaded and stored on the user's hard drive or other local device. When the user selects the media for viewing, playback of the media starts immediately (via the few minutes of previously downloaded content). During these first few minutes of playback, the rest of the media is downloaded. The user thus experiences no delay in viewing the selected media.

In another embodiment, if the user stops watching a media item before the media time is finished playing, the position where the user stopped viewing is recorded so that when the user returns to finish viewing the media item, the media item will start playing from the point where it was stopped.

In another embodiment, if after consolidating two or more libraries, duplicate media items are found, the duplicate media items will be sorted and displayed in an order according to user preference (i.e., by cost, resolution, etc.).

### Alternate Embodiments

Variations, modifications, and other implementations of what is described herein may occur to those of ordinary skill in the art without departing from the spirit and scope of the invention. Accordingly, the invention is not to be defined only by the preceding illustrative description.

What is claimed is:

1. A method of building a master digital media library from a plurality of separate digital media sources, the method comprising:
providing a location of each of the plurality of separate digital media sources, each of the plurality of separate digital media sources storing at least one digital media item, the at least one digital media item being one of owned by a user, rented by the user, saved to a queue by the user, or bookmarked by the user;
accessing the location of each of the plurality of separate digital media sources;
collecting from each of the plurality of separate digital media sources reference location information and metadata associated with the at least one digital media item stored at each of the plurality of separate digital media sources;
consolidating and storing the reference location information and the metadata associated with the at least one digital media item from each of the plurality of separate digital media sources into a database; and
presenting to the user the information stored in the database in readable and searchable form.

2. The method of claim 1, wherein the plurality of separate digital media sources comprises at least one of a digital media provider, a local disk drive, a digital file folder, an electronic device, and a network disk drive.

3. The method of claim 2, wherein the electronic device comprises at least one of a digital still camera, a digital video camera, a DVD (digital video disk) jukebox, a digital video recorder, a compact disk player, a laptop computer, a desktop computer, a mobile phone, and a home theater personal computer.

4. The method of claim 1, wherein the reference location information associated with the at least one digital media item comprises at least one of a disk path, a digital file folder location, a drive location, a memory location, and a uniform resource locator (URL).

5. The method of claim 1, wherein the metadata associated with the at least one digital media item comprises at least one of title, subject, artist, creator, director, cast, composer, description, genre, type, filename, source, publisher, format, date of production, running time, media display image, language, media cost, and media availability.

6. The method of claim 1, further comprising grouping, sorting, and filtering the consolidated and stored reference location information and metadata associated with the at least one digital media item from each of the plurality of separate digital media sources.

7. The method of claim 1, further comprising periodically updating the consolidated and stored reference location information and metadata associated with the at least one digital media item from each of the plurality of separate digital media sources.

8. A method of building a master digital media library from a plurality of separate digital media sources, the method comprising:
providing a location of each of the plurality of separate digital media sources, each of the plurality of separate digital media sources storing at least one digital media item, the at least one digital media item being one of owned by a user, rented by the user, saved to a queue by the user, or bookmarked by the user;
accessing the location of each of the plurality of separate digital media sources;
collecting from each of the plurality of separate digital media sources reference location information and metadata associated with the at least one digital media item stored at each of the plurality of separate digital media sources;
consolidating and storing the reference location information and the metadata associated with the at least one digital media item from each of the plurality of separate digital media sources into a database;
presenting to the user the information stored in the database in readable and searchable form; and
providing to the user a message indicating one of the availability of, the expiration of, the time left before the end of a blackout period of, or the time left before expiration of at least one of the at least one digital media item from each of the plurality of separate media sources.

9. The method of claim 8, wherein the plurality of separate digital media sources comprises at least one of a digital media provider, a local disk drive, a digital file folder, an electronic device, and a network disk drive.

10. The method of claim 9, wherein the electronic device comprises at least one of a digital still camera, a digital video camera, a DVD jukebox, a digital video recorder, a compact disk player, a laptop computer, a desktop computer, a mobile phone, and a home theater personal computer.

11. The method of claim 8, wherein the reference location information associated with the at least one digital media item comprises at least one of a disk path, a digital file folder location, a drive location, a memory location, and a uniform resource locator (URL).

12. The method of claim 8, wherein the metadata associated with the at least one digital media item comprises at least one of title, subject, artist, creator, director, cast, composer, description, genre, type, filename, source, publisher, format, date of production, running time, media display image, language, media cost, and media availability.

13. The method of claim 8, further comprising grouping, sorting, and filtering the consolidated and stored reference location information and metadata associated with the at least one digital media item from each of the plurality of separate digital media sources.

14. The method of claim 8, further comprising periodically updating the consolidated and stored reference location information and metadata associated with the at least one digital media item from each of the plurality of separate media sources.

15. A system for building a master digital media library from a plurality of separate digital media sources, the system comprising:
an input module configured for receiving and storing a location of each of the plurality of separate digital media sources, each of the plurality of separate digital media sources storing at least one digital media item, the at least one digital media item being one of owned by a user, rented by the user, saved to a queue by the user, or bookmarked by the user;
a collecting module configured for accessing the location of each of the plurality of separate digital media sources and collecting from each of the plurality of separate digital media sources reference location information and metadata associated with the at least one digital media item stored at each of the plurality of separate digital media sources;
a consolidating module configured for consolidating and storing the reference location information and the metadata associated with the at least one digital media item from each of the plurality of separate digital media sources into a database;
a presenting module configured for presenting to the user the information stored in the database in readable and searchable form, and for providing to the user a message indicating one of the availability of, the expiration of, the time left before the end of a blackout period of, or the time left before expiration of at least one of the at least one digital media item from each of the plurality of separate media sources.

16. A method of building a master digital media library from at least one digital media source, the method comprising:
providing a location of the at least one digital media source, the at least one digital media source storing at least one digital media item, the at least one digital media item being one of owned by a user, rented by the user, saved to a queue by the user, or bookmarked by the user;
accessing the location of the at least one digital media source;
collecting from the at least one digital media source reference location information and metadata associated with the at least one digital media item;
consolidating and storing the reference location information and the metadata associated with the at least one digital media item from the at least one digital media source into a database;
presenting to the user the information stored in the database in readable and searchable form; and
providing to the user a message indicating one of the availability of, the expiration of, the time left before the end of a blackout period of, or the time left before expiration of the at least one digital media item from the at least one digital media source.
